(19) United States
(12) Patent Application Publication
(10) Pub. No.: US 2009/0152021 A1
(43) Pub. Date: Jun. 18, 2009

(54) PLATFORM SCALE

(75) Inventor: Fabrizio Tamborini, Vergiate (Varese) (IT)

Correspondence Address: Pearne & Gordon LLP, 1801 East 9th Street, Suite 1200, Cleveland, OH, 44114-3108, US

(73) Assignee: IBR INDUSTRIE BILANCE RIUNITE S.P.A., 21100 Varese (IT)

(21) Appl. No.: 12/298,483

(22) PCT Filed: Apr. 28, 2006
(86) PCT No.: PCT/IT06/00296

§ 371 Date: Oct. 24, 2008

(51) Int. Cl. G01G 21/22

(52) U.S. Cl. 177/262

(57) ABSTRACT

It is disclosed a balance or platform scale consisting of a main body (2) of composite material, to which a predetermined number of load cells is linked as well as adjustable supporting means (4) of the main body (2) to enable the scale to rest on the ground. A scale thus made has a very reduced weight and reduced sizes.

The present invention relates to a platform scale or balance for determining the weight of articles up to 1500 kg and also 3000 kg, in the industrial field for example.

It is known that common balances presently used in the industrial field for determining the weight of a great number of different items have different construction structures.

Generally these platform scales consist of a frame and a respective counter-frame mutually coupled and having a square or rectangular plan shape, which are internally provided with a single load cell. The counterframe has four feet linked thereto for support and adjustment on the ground.

A suitable cable brings the load-cell signal to an electronic device capable of converting the signal into a weight measurement.

Mounted on the upper frame is a further bell-shaped dish or pan (made of bent sheet metal) designed to receive on its upper surface, the element whose weight is wished to be known.

The upper pan, frame and counter-frame are made of iron or stainless steel.

In particular, the above described scales are adapted to weigh small capacities until 1000-1500 kg for example.

There are also on the market other types of scales in which an iron frame is structurally connected to four load cells, in turn connected to a central junction box from which a cable exits, which cable brings the weight signal to the terminal for conversion into the desired measurement.

Then an upper cover made of iron or stainless steel and defining the support designed to receive the element whose weight is wished to be known is associated with the central iron frame.

The last-mentioned type of scale is suitable to measure capacities from some thousands of kilos to higher values.

While the platform scales briefly described above are presently widespread and largely used on the market, they however suffer from some drawbacks and/or operating limits.

First of all it is to be pointed out that, due to their own nature, the scales presently on the market are very heavy to carry. In fact they are completely or mainly made of iron or stainless steel and have sizes and thickness values adapted to withstand the above mentioned weight stresses.

As a result of the above, many difficulties are encountered for transport because it is always necessary to operate by means of suitable forklift trucks or similar apparatus. It is obvious that also in case of malfunctions, home servicing is required, which involves additional important repairing costs.

Since the scale pans and the frame are made of the above described materials, the load cells too must have a structure and strength adapted to bear the weight of the frame structure itself, in addition to the weight of the element to be weighed.

Furthermore, the balances presently on the market can be hardly personalised or customised because it is substantially impossible to carry out works on the covering bell with reduced costs.

Finally, for applications requiring electrical insulation of the element whose weight is wished to be known relative to the scale itself, further expedients are necessary such as additional elements to be interposed.

The present invention aims at substantially solving all the above mentioned drawbacks.

A first aim of the invention is to provide a very light-in-weight platform scale, the services it offers being the same as those of the scales presently in use.

Another aim of the invention is to provide a scale that can be transported without involving problems of logistic nature and that at the same time is of flexible use.

It is an auxiliary aim of the invention to make available a scale that can be easily customised depending on the particular technical and/or aesthetic requirements.

The foregoing and further aims, that will become more apparent in the course of the present specification are substantially achieved by a platform scale in accordance with the features recited in the appended claims.

Further features and advantages will be best understood from the detailed description of a preferred but not exclusive embodiment of a platform scale in accordance with the present invention.

This description will be set out hereinafter, with reference to the accompanying drawings given by way of non-limiting example, in which:

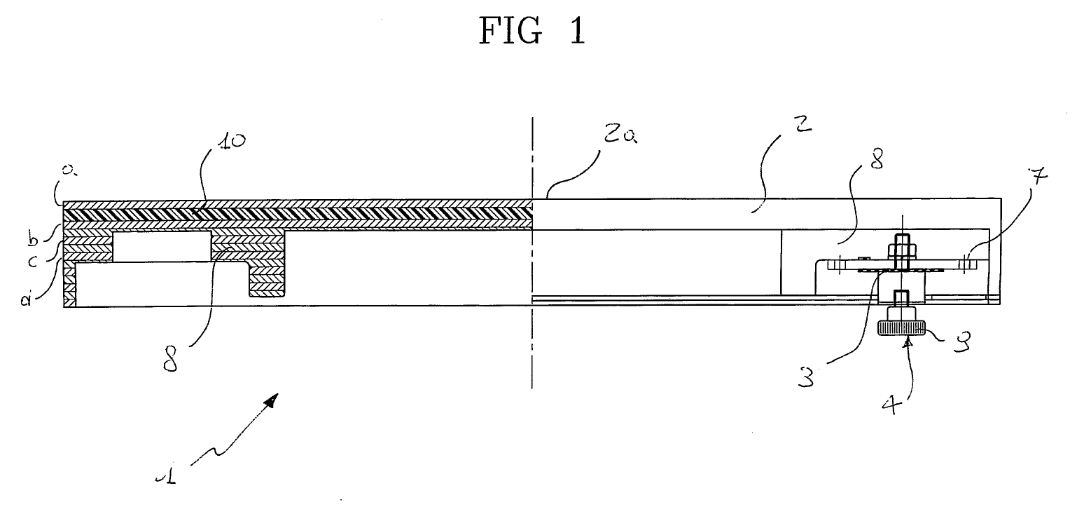

FIG. 1 is a cross-sectional view of a platform scale in accordance with the present invention;

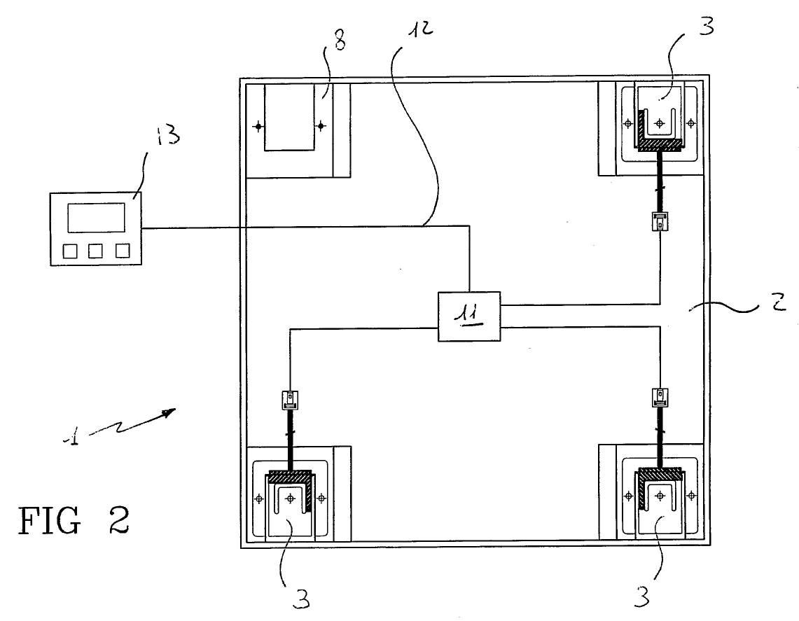

FIG. 2 is a bottom view of the platform scale shown in FIG. 1;

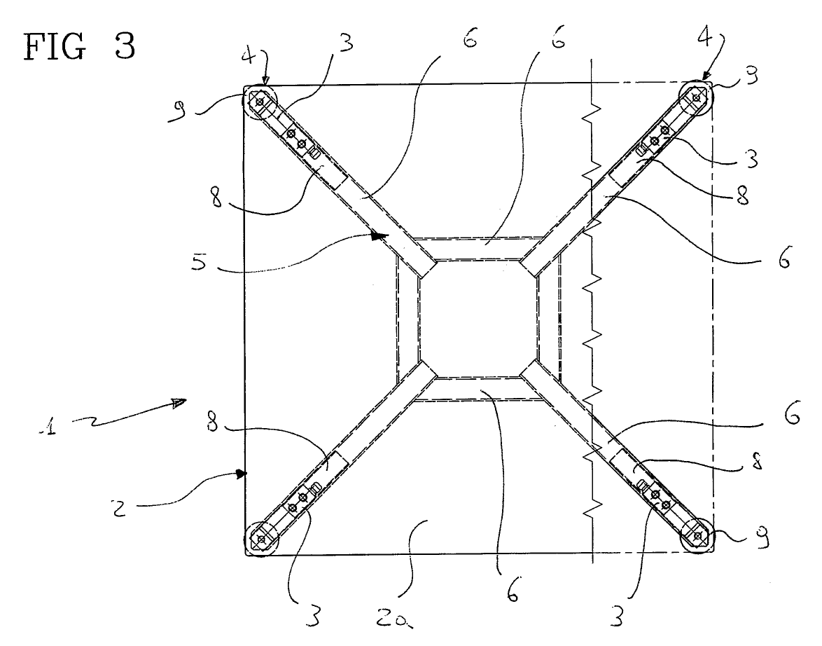

FIG. 3 is a top view partly sectioned of an alternative embodiment; and

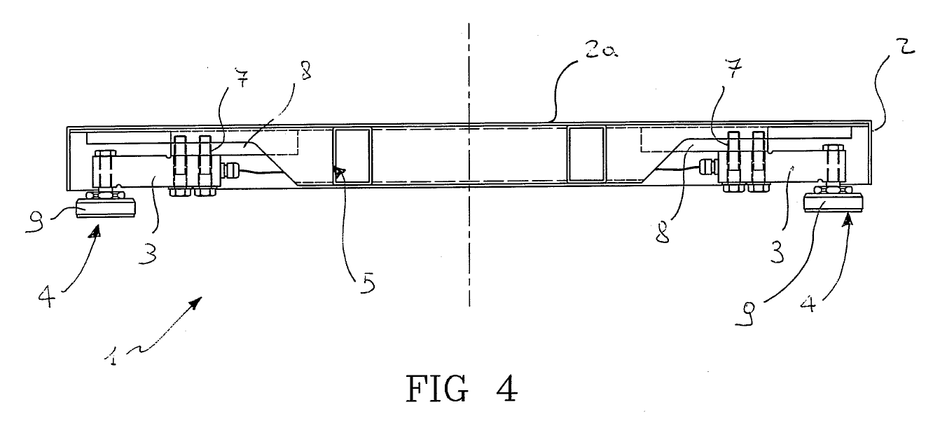

FIG. 4 shows a section taken along line A-A in FIG. 3.

With reference to the drawings, a platform scale or balance has been generally identified by reference numeral 1.

As shown in FIG. 1, said balance first of all comprises a main body 2 having an upper support surface 2a, a given number of load cells 3 associated with the main body 2 on the opposite side from the upper support surface and supporting means 4 for the main body 2.

The main body 2 has a substantially parallelepiped shape with a preferably but not exclusively square plan conformation. In particularly said main body 2 is at least partly (and generally fully) made of composite material.

Looking at the main body 2 in section it is possible to see that the same is a layer body (a, b, c, d, . . . ) and in particular comprises a plurality of successive layers disposed on top of each other.

Said layers are in the range of 2 to 15 and their number must be adapted to enable the balance to resist the weight stresses to which it is provided to be submitted in operation. In this regard the number of said layers will be more generally included between 7 and 13.

In more detail, the main body comprises several layers disposed on top of each other which are made of Kevlar and/or glass fibres and/or carbon fibres and/or aramidic or polyaramidic fibres buried into a suitable thermosetting resin.

In addition, the main body will be internally provided with at least one central core 10 of plastic material having a density included between 0.6 and 1.15, for example.

The core 10 is preferably made of a resin of polymeric material and will enable the main body to withstand the weight stresses to which it is submitted while keeping the sizes in height and the weight of the pan itself within reduced limits.

Then, as can be viewed from the figures, the platform scale does not comprise any covering element for the main body 2 which element was on the contrary present in the applications of known type.

In particular, the main body directly receives on its upper surface 2a, the element resting thereon and whose weight is wished to be known.

A main body 2 made in layers combined with the absence of the covering element enable the upper and in-sight surface of the main body to be conveniently customised. In fact, since a body made in layers is involved, it will be possible to replace the last layer keeping the underneath layers of the main body unchanged, without modifying the mechanical grip of the pan, but thereby enabling personalization of the pan itself.

It is in fact apparent that in this manner it will be possible to give the upper surface of the main body a shock-resistant finish, as well as to use either a conductive or a non-conductive material depending on requirements, or even a material suitable for food or a transparent material with internal personalization.

For instance, a scratch-resistant cover made of Kevlar can be conceived, as well as a carbon cover suitable for critical environments or also an antislip or scratch-resistant cover suitable for damp or wet environments, rich in water, of the food or chemical type.

Obviously, covers can be made of different colours and reproduce images or business logos for example.

By operating in this way the main body can have a thickness of 1 to 6 cm, while the thickness of the scales presently on the market is never less than 10 cm.

In addition, the main body thus made can bear weights even as high as 1500 kg on its upper surface 2a.

To enable the main body 2 to further increase its capacity, said body is provided to internally comprise at least one metal frame 5 made of an aluminium or light alloy material for example, so that it does not greatly increase the weight of the balance (FIGS. 3 and 4).

The frame 5 may comprise a plurality of rod-like elements 6 linked (welded) together, buried into or glued to the resin of composite material. The above will enable the structure to bear weights even as high as 3000 kg.

Furthermore, use of a level or similar device can be provided to signal the levelness of the main body 2. This level will be incorporated into the main body and will be visible at its upper surface 2a, being conveniently protected but allowing a comfortable use.

As can be seen in the accompanying figures, the platform scale shall also comprise four distinct load cells connected to a central junction box 11 from which a cable 12 destined to the measuring terminal 13 exits.

The load cells 3 herein adopted can be of the IP65 or IP67 type for example, i.e. they are water-resistant to such an extent that the device is adapted for operation in the presence of humidity or water.

In particular, the load cells 3 shall be made of aluminium or a light alloy of reduced height and shall be linked to the main body 2 by use of suitable screw threaded bushes 7 carried by supports 8 made of such materials as aluminium, light alloys or resin, buried into the main body 2 or in any case irremovably joined thereto.

In turn, the supporting means generally comprising a predetermined number of adjustable feet 9 to enable the balance to rest on the ground shall be directly linked to the load cells. In other words the feet shall be as many as the load cells and the overall structure of the scale shall have a height included between 2 and 7 cm, this height being much smaller than that of the balances currently in use and made of steel/iron.

Therefore, looking at the overall structure of the scales being the object of the present invention it is possible to notice that the same are exclusively formed with three constituent elements: the main body 2 to which the load cells 3 are linked which load cells are directly connected to the support feet 9.

The invention achieves important advantages.

The scale made of carbon and composite material is very light and therefore can be easily transported. By way of example, a standard balance of iron or steel the plan sizes of which are 1500×1500 mm will have a weight of 170 to 200 kg; vice versa, the weight of a scale of the same sizes and capacity made of composite material will be 27-30 kg.

The above involves very important advantages both in terms of transport and delivery of the article by the manufacturer, and in terms of management and servicing by the purchaser.

In fact for example, it will be possible to send the scales to a maintenance shop for servicing, thereby avoiding the visit of a technician, and it will be also possible to change the position of said scales at the inside of the enterprise so that there will be a decrease in the number of scales required or in any case a reduction in the handling times.

The scales thus made are in any case very performing, capable of bearing weights as big as 1500 kg and even up to 3000 kg, while at the same time withstanding the most extreme stresses due to the fact that they are made of innovative materials.

These scale may also be equipped with a lifting handle to facilitate transport of same even more, due to their being also light in weight.

These scales are also flexible because their surfaces are fully interchangeable (for instance, made of Kevlar to resist scratches and to be antislip, of carbon for critical environments, etc.).

Finally said scales can be personalised or customised because the covers can be made of different colours and adorned with images and business logos upon request, without involving additional production costs.

Furthermore, the device has an important fatigue strength and its mechanical features do not decay in time.

1-19. (canceled)

20. A platform scale comprising:
a main body (2) having an upper support surface (2a);
a predetermined number of load cells (3) associated with the main body (2) on the opposite side from the upper support surface; and
supporting means (4) of the main body (2), wherein the main body (2) is at least partly made of a composite material and is a layer body comprising a plurality of layers made of different composite materials disposed on top of each other.

21. A platform scale as claimed in claim 20, wherein the main body (2) is a layer body comprising a plurality of layers disposed on top of each other consisting of 3 to 15 layers.

22. A platform scale as claimed in claim 20, wherein the main body comprises layers made of Kevlar and/or glass fibres, and/or carbon fibres, and/or aramidic or polyaramidic fibres.

23. A platform scale as claimed in claim 20, wherein the main body (2) comprises a central core of plastic material of a density included between 0.6 and 1.15.

24. A platform scale as claimed in claim 23, wherein the core is made of a resin of polymeric material.

25. A platform scale as claimed in claim 20, wherein the main body (2) internally comprises at least one metal frame (5), made of an aluminium or light alloy material.

26. A platform scale as claimed in claim 25, wherein said frame (5) comprises a plurality of rod-like elements (6) linked to each other and buried into the resin of the composite material.

27. A platform scale as claimed in claim 20, wherein the platform scale does not include any covering element for the main body (2), said main body directly receiving on its upper surface (2a), the element/elements resting thereon and whose weight is wished to be known.

28. A platform scale as claimed in claim 20 wherein the main body is of a thickness included between 1 and 6 cm.

29. A platform scale as claimed in claim 20, wherein the main body (2) is fully made of composite material.

30. A platform scale as claimed in claim 20, wherein the load cells (3) are made of an aluminium or light alloy material.

31. A platform scale as claimed in claim 20, wherein the load cells (3) are linked to the main body (2) by screw threaded bushes (7), carried by supports (8) made of resin, aluminium or light alloy which are irremovably joined to the main body (2).

32. A platform scale as claimed in claim 20, wherein the platform scale comprises four load cells (3).

33. A platform scale as claimed in 20, wherein the supporting means (4) of the main body (2) is directly linked to the load cells (3).

34. A platform scale as claimed in claim 20, wherein the supporting means (4) of the main body (2) comprises a predetermined number of feet (9) that are adjustable, to enable the scale to rest on the ground.

35. A platform scale as claimed in claim 20, wherein the main body can bear weights reaching a value as high as 3000 kg on its upper surface (2a).

36. A platform scale as claimed in claim 20, wherein the upper surface (2a) can have a shock-resistant finish, a non-conductive finish, a finish suitable for food or personalised.

37. A platform scale as claimed in claim 20, wherein the main body (2) has a substantially parallelepiped shape with a square or rectangular plan conformation.

38. A platform scale as claimed in 20, wherein the platform scale has a height included between 2 and 7 cm.

39. A platform scale comprising:
a main body (2) having an upper support surface (2a);
a predetermined number of load cells (3) associated with the main body (2) on the opposite side from the upper support surface; and
supporting means (4) of the main body (2), the main body being made of at least a composite material, wherein the supporting means (4) of the main body (2) and comprises a predetermined number of feet (9) directly linked to the load cells (3) to enable the scale to rest on the ground.
